(19) United States
(12) Patent Application Publication
(10) Pub. No.: US 2013/0238608 A1
(43) Pub. Date: Sep. 12, 2013

(54) SEARCH RESULTS BY MAPPING ASSOCIATED WITH DISPARATE TAXONOMIES

(71) Applicants: Ka Cheung Sia, Bellevue, WA (US); Kyrylo Tropin, Redmond, WA (US); Bhuvan Middha, Issaquah, WA (US); Paul Nathan Bennett, Kirkland, WA (US); Krysta M. Svore, Seattle, WA (US)

(72) Inventors: Ka Cheung Sia, Bellevue, WA (US); Kyrylo Tropin, Redmond, WA (US); Bhuvan Middha, Issaquah, WA (US); Paul Nathan Bennett, Kirkland, WA (US); Krysta M. Svore, Seattle, WA (US)

(73) Assignee: Microsoft Corporation, Redmond, WA (US)

(21) Appl. No.: 13/413,651

(22) Filed: Mar. 7, 2012

(51) Int. Cl. G06F 17/30

(52) U.S. Cl. 707/723; 707/E17.014

(57) ABSTRACT

Architecture that generates signals/features that capture the match between intent of a query and category of documents. For example, for a query intent related to “autos”, documents that belong to categories related to “Autos” receive a higher score than documents of a “computers” category. The architecture can be applied to a search ecosystem where query intent classification and document category classifier are available, learns the mapping between query intent and document category, and introduces category-match features to a ranking algorithm, thereby improving search result relevance. The architecture learns the mapping between two existing and different taxonomies to create a category match signal from which the ranking algorithm can learn. Moreover, architecture adapts to a complex ecosystem where different taxonomies on the query side and document side exist through learning a mapping score between at least two taxonomies.

### BACKGROUND

Many of the signals/features used in search engine ranking are based on keyword matching between query words and documents. This can return had results when an irrelevant document matches the query words. For example, the query {“what do we mean by hypothesis”} may return many documents about statistical hypothesis testing, since the word “mean” matches with documents about statistics in the sense of “average”. Matching a query and documents in the concept space has been addressed in academic research as well as the industry. Many of the applications attempt to associate queries and documents to the same concept space under a unified taxonomy, which is not easily interpreted.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture generates signals/features that capture the match between intent of a query and category of documents. For example, for a query intent related to “autos”, documents that belong to categories related to “autos” receive a higher score than documents of a “computers” category.

The architecture can be applied to a search ecosystem where query intent classification and document category classifier are available, learns the mapping between query intent and document category, and introduces category-match features to a ranking algorithm, thereby improving search result relevance. The architecture learns the mapping between at least two existing taxonomies, whether the same or different, to create a category match signal from which the ranking algorithm can learn. Moreover, architecture adapts to a complex ecosystem where different taxonomies on the query side and document side exist through learning a mapping score between at least two taxonomies.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a flow diagram for training a ranking algorithm for query intent and document categories.

FIG. 3 illustrates a method in accordance with the disclosed architecture.

FIG. 4 illustrates further aspects of the method of FIG. 3.

FIG. 5 illustrates an alternative method in accordance with the disclosed architecture.

FIG. 6 illustrates further aspects of the method of FIG. 5.

FIG. 7 illustrates a block diagram of a computing system that executes disparate taxonomy matching and mapping in accordance with the disclosed architecture.

### DETAILED DESCRIPTION

The disclosed architecture enables the relating of items in at least two taxonomies, whether the same or different. Mappings are created between the items based on translation models can operate as part of a mapping component, although this capability can be employed separately from the mapping component. Features are then created from these mappings, and used as input to training an algorithm, such as a ranking algorithm. Generally, in the context of search engines and search results, query intent is received in one taxonomy, and the search results are received in a different taxonomy and classified as categories of documents related to the query intent. Mappings are created between the query intent and the categories of documents. A ranked list of probable mappings is created and from which a top ranked mapping is selected at the most likely relation between the query intent and the category of documents. The top mapping and possibly other mappings can then be utilized as feature signals for input to a ranker algorithm.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

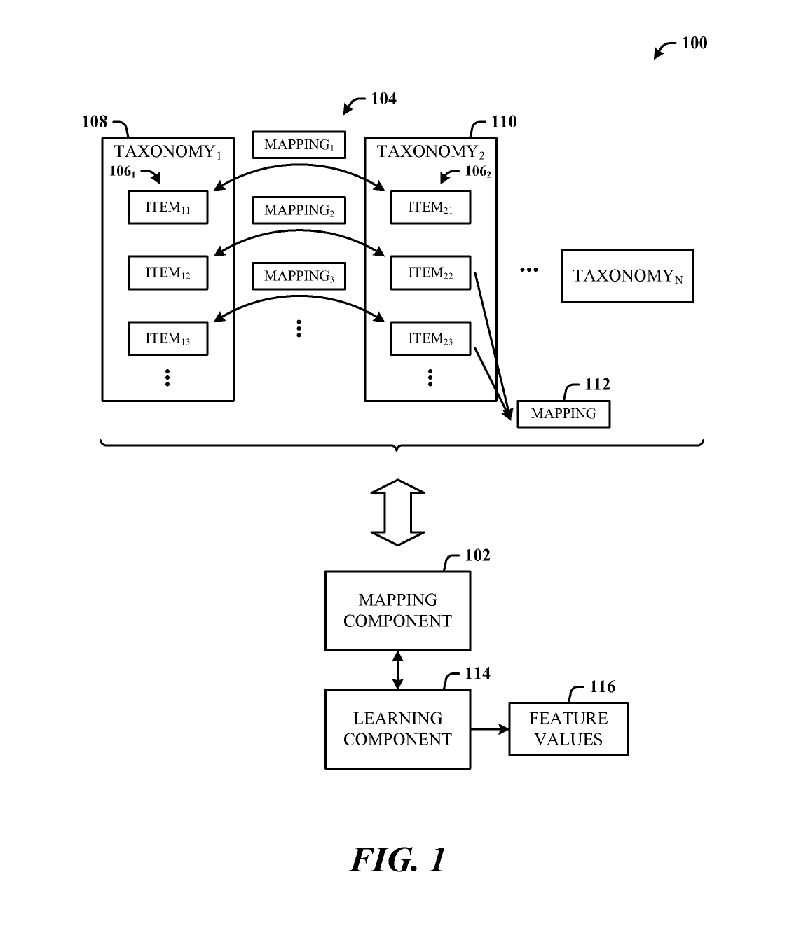

FIG. 1 illustrates a system 100 in accordance with the disclosed architecture. The system 100 can include a mapping component 102 that generates mappings 104 between items 106 of different taxonomies (e.g., items 106₁ of a first taxonomy 108, and items 106₂ of a second (and different) taxonomy 110). Alternatively, or in combination therewith, other mappings (e.g., a mapping 112) can be generated between items (e.g., an Item₂₂ and an Item₂₃ of the items 106₂) of a single taxonomy (e.g., the second taxonomy 110). A learning component 114 learns the mappings (e.g., mappings 104 and mapping 112) and outputs feature values 116 for several desired features for use by a ranking algorithm (not shown).

The items 106 of the different taxonomies (108 and 110) can be query intent of a first taxonomy 108 and categories of results of the second taxonomy 110. For example, if the query intent is derived and provided to the system 100 as “autos”, the items 106₁ of the first taxonomy 108 are all the query intent “autos”. The items 106₂ of the second taxonomy 110 can then be the derived categories (also referred to as classes) of search results, such as recreation/autos, recreation, shopping, business, etc. Thus, the items of a single taxonomy (e.g., taxonomy 110) can be categories of results for the query intent of a query.

The mapping component 102 computes query intent entropy over all items of query intent (the items 106₁ of the first taxonomy 108). The mappings (104 and 112) can be characterized as scores that are ranked to select an optimum mapping. The mappings (104 and 112) can be computed as a probability that the items are related. The mapping component 102 includes translation capability to translate classes (categories) derived by a classifier between items of the taxonomies (108 and 110) or between categories of the single taxonomy (taxonomy 110). The mapping component 102 can also apply a threshold to limit membership of query intent and the classes (categories).

Following is an example set of different taxonomies of query intent (QI) and results as document category (DC) (also used in a specific implementation of ODP-open document project) when the query intent is derived as “autos”. Note, however, that the disclosed architecture is not limited to ODP and QI classification as the taxonomies, as other taxonomies can be utilized.

| Query Intent (QI) | Document Category (DC) | P(DC\|QI) |
|---|---|---|
| autos | Recreation/Autos | 0.136731852 |
| autos | Recreation | 0.133535852 |
| autos | Shopping | 0.09483577 |
| autos | Business | 0.081165749 |
| autos | Arts | 0.058255807 |
| autos | Shopping/Vehicles | 0.052116955 |
| autos | Sports | 0.046674261 |
| autos | Science | 0.034649706 |
| autos | Computers | 0.033921904 |

As indicated, for all query intent items of “autos”, approximately 13% (0.136731852) of the “good” and relevant pages (documents) belong to the category “Recreation/Autos”. Given this kind of data, features can be constructed to signal the degree of match between a query and documents, respectively, depending on the intent and category to which the document belongs.

Following is a pseudo-code for this particular example, that introduces the following signals to the ranker (ranking algorithm):

if ((query intent is autos) && (category of the page belongs to
Recreation/Autos of high confidence))
{

return 0.136731852

}
else
{

return 0

}

Following is a more detailed description of mappings across and/or within disparate taxonomies to improve relevance in searches.

Given an intent class of a query, then documents (as associated with document URLs) that have the same intent class are, intuitively, more likely to be relevant. In the case where classifications are available for both the query and document, but the taxonomies differ, gains are still possible. This is accomplished by a translation model that estimates predictions from one domain to the other and generates such features. This description is on the basis that the taxonomies are over similar query intents. Both taxonomies can have different classification schemes, with a mapping defined therebetween.

In a first example translation model, let d be a particular document (URL—uniform resource locator). Let r(d,q) be the event that document J has a relevance-level of at least θ for query q. where θ=“Good”. When the query q and document d are clear (unambiguous) from context, write r rather than r(d,q). Let C(d)εODP denote the ODP class of a document d. Let I(g)εIntents indicate the intent class of a query q. Note that in this example implementation, the query intents are derived using a query classification scheme. Let

$$t ( i , d , q ) = c {=}^{det} I ( q ) = i , C ( d ) = c , r ( d , q ) \geq θ ,$$

that is, it is defined to be the conjunctive event where the intent of the query is i, the class of document is c, and the relevance of document-query pair (d,q) is r≧θ. When the document and query are clear from context, this is abbreviated as t(i)=c. A goal is to determine how often a document with class c for a query with intent q has relevance, at least θ. P(r|d,q). Then derive an estimate for P(r|d, q).

The translation model estimates this as:

$$P ( r \vert d , q ) = {\sum }_{c ∈ ODP} {\sum }_{i ∈ Intents} \frac{P ( C ( d ) = c \vert d ) P ( d )}{P ( c )} P ( C ( d ) = c , r ( d , q ) \geq θ \vert i ) P ( I ( q ) = i \vert q )$$

The first piece,

$$\frac{P ( C ( d ) = c \vert d )}{P ( c )} ,$$

is obtained from the ODP classifiers, in this example embodiment, on documents in the index. P(d) is assumed to be one. The denominator P(c) is a prior over the indexed web,

$$\frac{Σδ ( C ( d ) = c \vert d \geq 0.7 )}{\vert d \vert} .$$

The second piece, P(C(d)=c,r(d,q)≧θ|i), is calculated based on document-query pairs d, q, where r(d,q)≧θ, s.t. θ==Good, and P(C(d)=c|d)≧0.7. The final piece, P(I(q)=i|q), is the probability of the query classifier intent given the query, and is obtained from the query intent classifiers.

With respect to feature derivation for this first model, features (feature values) can be derived that include KL (Kullback-Leibler) divergence, cross-entropy, etc. Translation follows between the document classes to the query intent space or from the query intent space to the document class space. In this description, translation is from the query intent space to the document class space using the core part of the formula above and determines the ODP (document category (DC) as previously used) class of the query, denoted as C(q). The class of a query is the class of the relevant documents (and associated URLs). It draws a random relative document, and then considers the probability of observing class c. Viewed as query classification, it follows that:

$$P ( C ( q ) = c \vert q ) {=}^{def} P ( C ( d ) = c \vert r ( d , q ) \geq θ , q )$$

In this case, given a particular type of query intent classifier, it is desired to transform this classifier view to an equivalent intent. Again, using the motivation that the class is the class of the relevant items, compute an “equivalent translation” of intent i. For the formula below, recall that the intents are not mutually exclusive.

$${P}_{i} ( C ( q ) = c \vert q ) = P ( C ( d ) = c \vert r ( d , q ) \geq θ , q , i ) P ( I ( q ) = i \vert r ( d , q ) \geq θ , q ) + P ( C ( d ) = c , \vert r ( d , q ) \geq θ , q , i ) P ( I ( q ) \neq i \vert r ( d , q ) \geq θ , q ) = P ( C ( d ) = c \vert r ( d , q ) \geq θ , i ) P ( I ( q ) = i \vert r ( d , q ) \geq θ , q ) + P ( C ( d ) = c , \vert r ( d , q ) \geq θ , i ) P ( I ( q ) \neq i \vert r ( d , q ) \geq θ , q )$$

where P(I(q)=i|r(d,q)≧θ,q) is the query classifier probability, P(I(q)≠i|r(d,q)≧θ,q) is the 1-(query classifier) probability, P(C(d)=c|r(d,q)≧θ,i) assumes the independence of q given that the intent is known and have some relevant document, and,

$$P ( C ( d ) = c \vert r ( d , q ) \geq θ , i ) ( likewise for not i ) = \frac{P ( C ( d ) = c , r ( d , q ) \geq θ \vert I ( q ) = i )}{P ( r ( d , q ) \geq θ \vert I ( q ) = i )}$$

For P(C(d)=c|r(d,q)≧θ|I(q)=i) and a data sample S, the extraction(s) can be,

$$P ( C ( d ) = c , r ( d , q ) \geq θ \vert I ( q ) = i ) = \frac{{Σ}_{( d , q ) ∈ S} P ( I ( q ) = i \vert q ) P ( C ( d ) = c \vert d ) δ ( r ( d , q ) \geq θ )}{{Σ}_{( d , q ) ∈ S} P ( I ( q ) = i \vert q )}$$

$$and , \\ P ( r ( d , q ) \geq θ \vert I ( q ) = i ) = \frac{{Σ}_{( d , q ) ∈ S} P ( I ( q ) = i \vert q ) δ ( r ( d , q ) \geq θ )}{{Σ}_{( d , q ) ∈ S} P ( I ( q ) = i \vert q )}$$

Thus, together:

$$P ( C ( d ) = c \vert r ( d , q ) \geq θ , i ) = \frac{{Σ}_{( d , q ) ∈ S} P ( I ( q ) = i \vert q ) P ( C ( d ) = c \vert d ) δ ( r ( d , q ) \geq θ )}{{Σ}_{( d , q ) ∈ S} P ( I ( q ) = i \vert q ) δ ( r ( d , q ) \geq θ )}$$

where P(C(d)=c|r(d,q)≧θ, i) is the translation model and is likewise for not i,

Finally, putting it all together:

$${P}_{i} ( C ( q ) = c \vert q ) = \frac{{Σ}_{( d , q ) ∈ S} P ( I ( q ) = i \vert q ) P ( C ( d ) = c \vert d ) δ ( r ( d , q ) \geq θ )}{{Σ}_{( d , q ) ∈ S} P ( I ( q ) = i \vert q ) δ ( r ( d , q ) \geq θ )} P ( I ( q ) = i \vert r ( d , q ) \geq θ , q ) + \frac{{Σ}_{( d , q ) ∈ S} P ( I ( q ) \neq i \vert q ) P ( C ( d ) = c \vert d ) δ ( r ( d , q ) \geq θ )}{{Σ}_{( d , q ) ∈ S} P ( I ( q ) \neq i \vert q ) δ ( r ( d , q ) \geq θ )} P ( I ( q ) \neq i \vert r ( d , q ) \geq θ , q )$$

Recall that the ODP document classes are not mutually exclusive; thus, consider the following formulation:

$${P}_{i} ( C ( q ) = c \vert q ) = \frac{{Σ}_{( d , q ) ∈ S} P ( I ( q ) = i \vert q ) P ( C ( d ) = c \vert d ) δ ( r ( d , q ) \geq θ )}{{Σ}_{( d , q ) ∈ S} P ( I ( q ) = i \vert q ) δ ( r ( d , q ) \geq θ ) {Σ}_{c} P ( C ( d ) = c \vert d )} P ( I ( q ) = i \vert r ( d , q ) \geq θ , q ) + \frac{{Σ}_{( d , q ) ∈ S} P ( I ( q ) \neq i \vert q ) P ( C ( d ) = c \vert d ) δ ( r ( d , q ) \geq θ )}{{Σ}_{( d , q ) ∈ S} P ( I ( q ) \neq i \vert q ) δ ( r ( d , q ) \geq θ ) {Σ}_{c} P ( C ( d ) = c \vert d )} P ( I ( q ) \neq i \vert r ( d , q ) \geq θ , q )$$

Additionally, where the production constraints imply that P(I(q)=i|q) is only known precisely when P(I(q)=i|q)≧0.7, then the following formulation can be utilized:

$${P}_{i} ( C ( q ) = c \vert q , i \geq 0.7 ) = \frac{{\sum }_{( d , q ) ∈ S} P ( I ( q ) = i \vert q ) P ( C ( d ) = c \vert d ) δ ( r ( d , q ) \geq θ )}{{\sum }_{( d , q ) ∈ S} P ( I ( q ) = i \vert q ) δ ( r ( d , q ) \geq θ ) {\sum }_{c} P ( C ( d ) = c \vert d )} P ( I ( q ) = i \vert r ( d , q ) \geq θ , q ) + \frac{{\sum }_{( d , q ) ∈ S} P ( I ( q ) \neq i \vert q ) P ( C ( d ) = c \vert d ) δ ( r ( d , q ) \geq θ )}{{\sum }_{( d , g ) ∈ S} P ( I ( q ) \neq i \vert q ) δ ( r ( d , q ) \geq θ ) {\sum }_{c} P ( C ( d ) = c \vert d )} P ( I ( q ) \neq i \vert r ( d , q ) \geq θ , q )$$

which is the same as the formulation above. In other words, when intent is known, nothing needs to be done differently; otherwise:

$${P}_{i} ( C ( q ) = c \vert q , i < 0.7 ) = \frac{{\sum }_{( d , q ) ∈ S} P ( I ( q ) = i \vert q ) P ( C ( d ) = c \vert d ) δ ( r ( d , q ) \geq θ ) δ ( i < 0.7 )}{{\sum }_{( d , q ) ∈ S} P ( I ( q ) = i \vert q ) δ ( r ( d , q ) \geq θ ) δ ( i < 0.7 ) {\sum }_{c} P ( C ( d ) = c \vert d )}$$

An alternative way is to calculate the following:

$${P}_{i} ( C ( q ) = c \vert q ) = \frac{{\sum }_{( d , q ) ∈ S} P ( I ( q ) = i \vert q ) \hat{P} ( C ( d ) = c \vert d ) δ ( r ( d , q ) \geq θ )}{{\sum }_{( d , q ) ∈ S} P ( I ( q ) = i \vert q ) δ ( r ( d , q ) \geq θ )} P ( I ( q ) = i \vert r ( d , q ) \geq θ , q ) + \frac{{\sum }_{( d , q ) ∈ S} P ( I ( q ) \neq i \vert q ) \hat{P} ( C ( d ) = c \vert d ) δ ( r ( d , q ) \geq θ )}{{\sum }_{( d , q ) ∈ S} P ( I ( q ) \neq i \vert q ) δ ( r ( d , q ) \geq θ )} P ( I ( q ) \neq i \vert r ( d , q ) \geq θ , q ) .$$

To address a log zero problem, consider a smoothed version of P(C(q)=c|q). Let,

$${P}_{i} ( C ( q ) = c \vert q ) = \frac{{P}_{i} ( C ( q ) = c \vert q )}{{\sum }_{c} {P}_{i} ( C ( q ) = c \vert q )} , \\ P ( C ( d ) = c \vert d ) = \frac{P ( C ( d ) = c \vert d )}{{\sum }_{c} P ( C ( d ) = c \vert d )} .$$

Then calculate,

$${\tilde{P}}_{i} ( C ( q ) = c \vert q ) = \frac{{\hat{P}}_{t} ( C ( q ) = c \vert q ) + m p}{1 + m} , \\ \tilde{P} ( C ( d ) = c \vert d ) = \frac{\hat{P (} C ( d ) = c \vert d ) + m p}{1 + m} ,$$

where mε(0,1), typically m=0.001, and

$$p = \frac{1}{\vert c \vert} .$$

In one example implementation, |c|=219.

The matching features between the distributions can be derived. With respect to KL divergence:

$${D}_{KL} ( {P}_{i} ( C ( q ) = c \vert q ) \vert \vert P ( C ( d ) = c \vert d ) ) = {\sum }_{c} {\hat{P}}_{i} ( C ( q ) = c \vert q ) log \frac{{\hat{P}}_{i} ( C ( q ) = c \vert d )}{\tilde{P} ( C ( d ) = c \vert d )} ,$$

where

$$0 log 0 {=}^{def} 0.$$

Note, the smoothed version is used in the denominator to avoid infinity. In support of determining the features, the query intent entropy is considered:

$$H ( P ( I ( q ) = i \vert q ) ) = - {\sum }_{i ∈ Intents} P ( I ( q ) = i \vert q ) log P ( I ( q ) = i \vert q ) ,$$

where P(i|q) is obtained from the query intent classifiers. Note this feature is not computed per intent, but rather over all intents. There will be only one of these features in the model. Since intents are not mutually exclusive, a normalized version can be used:

$$\hat{P} ( I ( q ) = i \vert q ) = \frac{P ( I ( q ) = i \vert q )}{{\sum }_{i ∈ Intents} P ( I ( q ) = i \vert q )} , \\ H ( \hat{P} ( I ( q ) = i \vert q ) ) = - {\sum }_{i ∈ Intents} \hat{P} ( I ( q ) = i \vert q ) log \hat{P} ( I ( q ) = i \vert q ) ,$$

With respect to query class entropy:

$$H ( {P}_{i} ( C ( q ) = c \vert q ) ) = - {\sum }_{c} {\hat{P}}_{i} ( C ( q ) = c \vert q ) log {\hat{P}}_{i} ( C ( q ) = c \vert q )$$

With respect to cross entropy:

$$H ( {P}_{i} ( C ( q ) = c \vert q ) , P ( C ( d ) = c \vert d ) ) = H ( {P}_{i} ( C ( q ) = c \vert q ) ) + {D}_{KL} ( {P}_{i} ( C ( q ) = c \vert q ) \vert \vert P ( C ( d ) = c \vert d ) ) = - {\sum }_{c} {\hat{P}}_{i} ( C ( q ) = c \vert q ) log \tilde{P} ( C ( d ) = c \vert d ) ,$$

where

$$0 log 0 {=}^{def} 0.$$

Document classes can be employed as |c|=219 binary features, for example, by considering one feature per class. If the document is of that class, then the feature value is one, else the value is zero.

Query intents (e.g., under query intent classification) can be employed as |i| binary features, by considering one feature per intent. If the query is of that intent, then the feature values is one; else, zero.

In both cases, a threshold can be employed to determine class/intent membership. For example, a threshold of 0.7 may be reasonable. Alternatively, the values of the features can be the actual probabilities. There is still one feature per class/intent, with values between zero and one, indicating probability of membership.

The matching features described in the preceding section are computed per intent, thus, there is one of each type per intent. This is because the intents may not be mutually exclusive and exhaustive (they may not some to unity). Rather than perform ad-hoc normalization, the translation above can be performed separately for each intent, resulting in features per intent. Features that are weighted can also be employed. Alternatively, or in combination therewith, the minimum among all intents can be obtained to make the KL divergence/cross entropy features more comparable across queries having one or multiple intent.

An alternative translation model translates the category membership of the documents.

P(r(d,q)|I(q),c(d)) is approximately (the number of relevant documents with that class in that intent)/(number of documents with that class in that intent).
Call the intent of a document I(d)=i defined to be sum over all query of P(q) r(d,q),I(q)=i,

$$P ( r ( d , q ) , I ( q ) = i \vert d , q ) {\sum }_{c} P ( r ( d , q ) , I ( q ) = i \vert d , c ) P ( c \vert d ) = {\sum }_{c} P ( r ( d , q ) , \vert I ( q ) = i , d , c ) P ( I ( q ) = i \vert d , c ) P ( c \vert d )$$

$$P ( r ( d , q ) , I ( q ) = i \vert d ) = {\sum }_{-} qP ( r ( d , q ) , I ( q ) = i \vert q , d ) P ( q \vert d ) = {\sum }_{q} P ( r ( d , q ) \vert I ( q ) = i , q , d ) P ( I ( q ) = i \vert q , d ) P ( q \vert d )$$

With respect to training data, it is assumed a search history exists for each user that comprises the queries issued, the list of documents in the visible search results, and the list of documents selected (e.g., clicked on) by the user in response to each query. Existing techniques for interpreting click-through information as a relevance signal can be employed in combination with the disclosed probabilistic models. One approach, for example, equates a user's click on a document with the observation as relᵤ (d,q)=1, and conversely, the lack of a click, as relᵤ(d, q)=0. The user's parameters can be estimated by maximizing the likelihood of the observed click-through data. The complexity associated with the foregoing method can be simplified by way of making simple approximation—it is assumed that the user's intended topic (true intent Tᵤ) is equal to the topic of the document the user selected (click on). Specifically, let d₁ . . . , d_{c} be the documents that the user clicks on for query q. Then, let

$${\hat{Pr} ( T )}_{t} = \frac{1}{c} {\sum }_{i = 1}^{c} Pr ( T \vert {d}_{i} )$$

where the document topic distributions are computed by the classifier and the subscript t refers to a specific query. Then, the training data for each user comprises of a set of pairs (qₜ, [symbol] (T)ₜ).

This approximation corresponds to ignoring the negative data points (documents that a user does not select), assuming that a click implies that the user thinks that the document is relevant, and assuming that Pr(covᵤ(d,q)|Tᵤ,T_{d})=0, if Tᵤ≠T_{d}. The first two assumptions become less significant the more training data that is collected for a user.

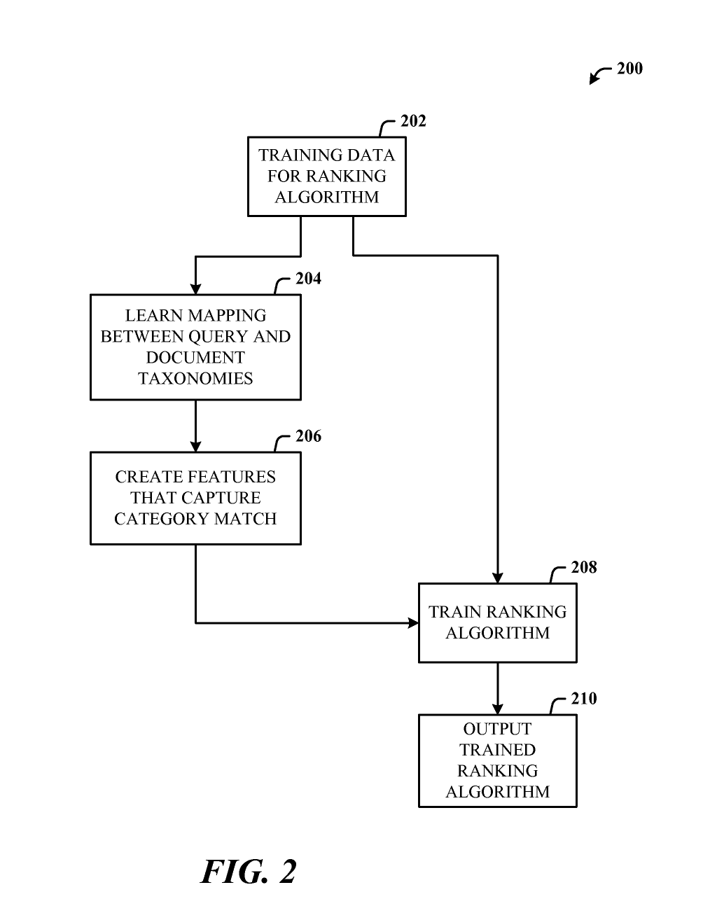

FIG. 2 illustrates a flow diagram 200 for training a ranking algorithm for query intent and document categories. However, it is to be understood that the disclosed architecture can be applied to advertisements on web documents (e.g., web pages), as well. At 202, training data is provided to a ranking algorithm. Flow can now occur along parallel branches. In a mapping branch, at 204, mapping between query intent and document taxonomies, is learned. At 206, features are created that capture a matching category. At 208, the ranking algorithm is then trained based on the features. As illustrated, alternatively, or in combination therewith, training can use the features, or not use the features and take the training data directly, as illustrated in the direct branch from 202. At 210, the trained ranking algorithm is then output.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

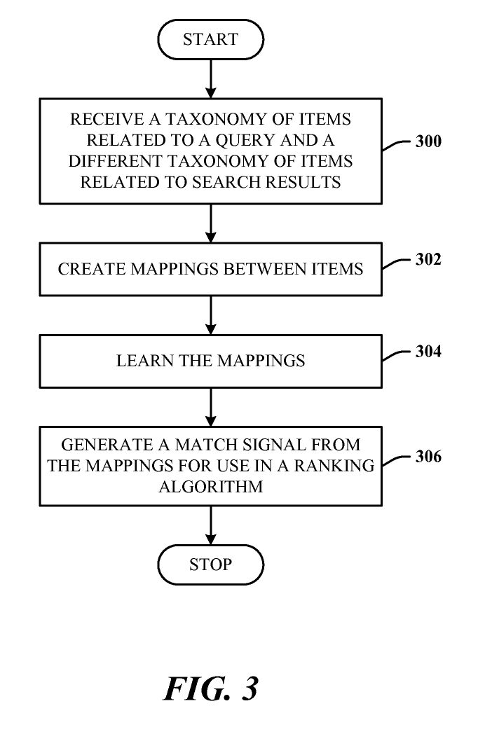

FIG. 3 illustrates a method in accordance with the disclosed architecture. At 300, a taxonomy of items related to a query is received and a different taxonomy of items is received related to search results. At 302, mappings are created between items. At 304, the mappings are learned. At 306, a match signal is generated from the mappings for use in a ranking algorithm.

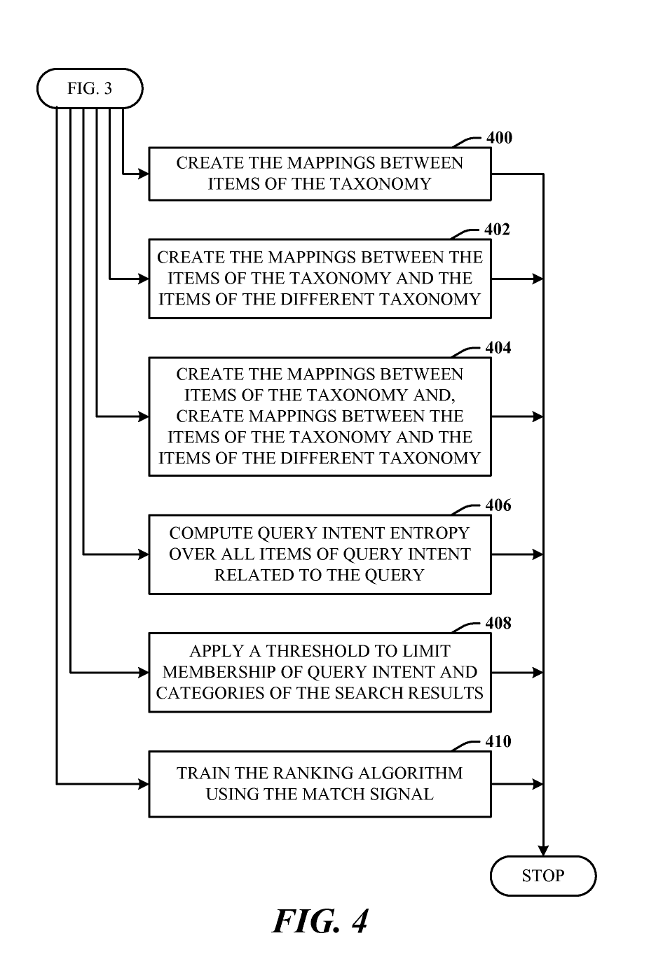

FIG. 4 illustrates further aspects of the method of FIG. 3. Note that the flow indicates that each block can represent a step that can be included, separately or in combination with other blocks, as additional aspects of the method represented by the flow chart of FIG. 3. At 400, the mappings are created between items of the taxonomy. At 402, the mappings are created between the items of the taxonomy and the items of the different taxonomy. At 404, the mappings are created between items of the taxonomy and, mappings are created between the items of the taxonomy and the items of the different taxonomy. At 406, query intent entropy is computed over all items of query intent related to the query. At 408, a threshold is applied to limit membership of query intent and categories of the search results. At 410, the ranking algorithm is trained using the match signal.

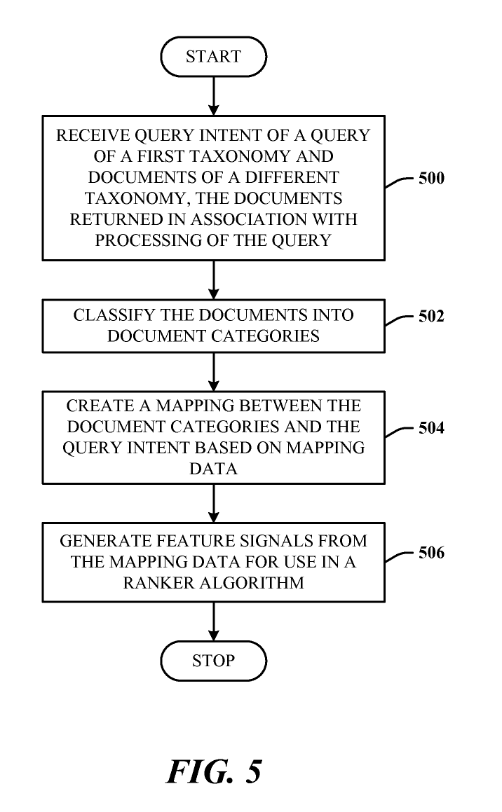

FIG. 5 illustrates an alternative method in accordance with the disclosed architecture. At 500, query intent of a query is received of a first taxonomy and documents are received of a different taxonomy. The documents are returned in association with processing of the query in a search environment. At 502, the documents are classified into document categories. At 504, a mapping is created between the document categories and the query intent based on mapping data. At 506, feature signals are generated from the mapping data for use in a ranker algorithm.

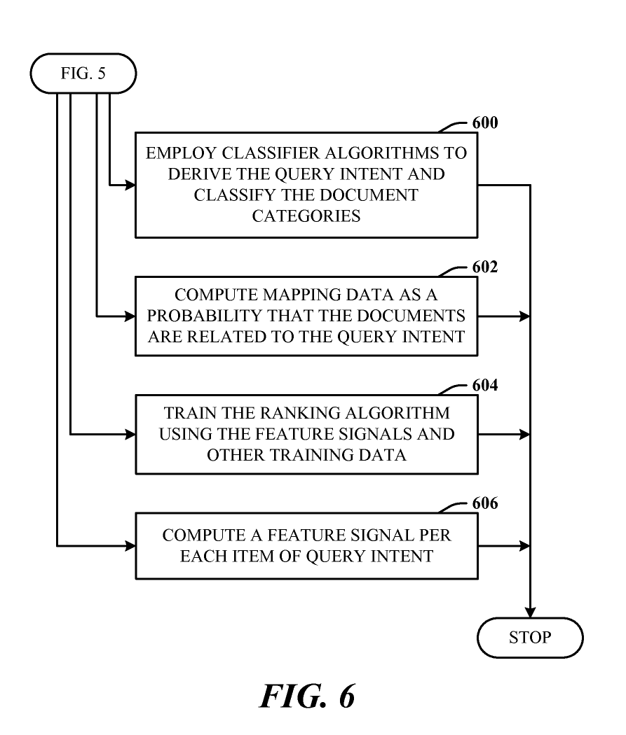

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, classifier algorithms are employed to derive the query intent and classify the document categories. At 602, the mapping data is computed as a probability that the documents are related to the query intent. At 604, the ranking algorithm is trained using the feature signals and other training data. At 606, a feature signal is computed per each item of query intent.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

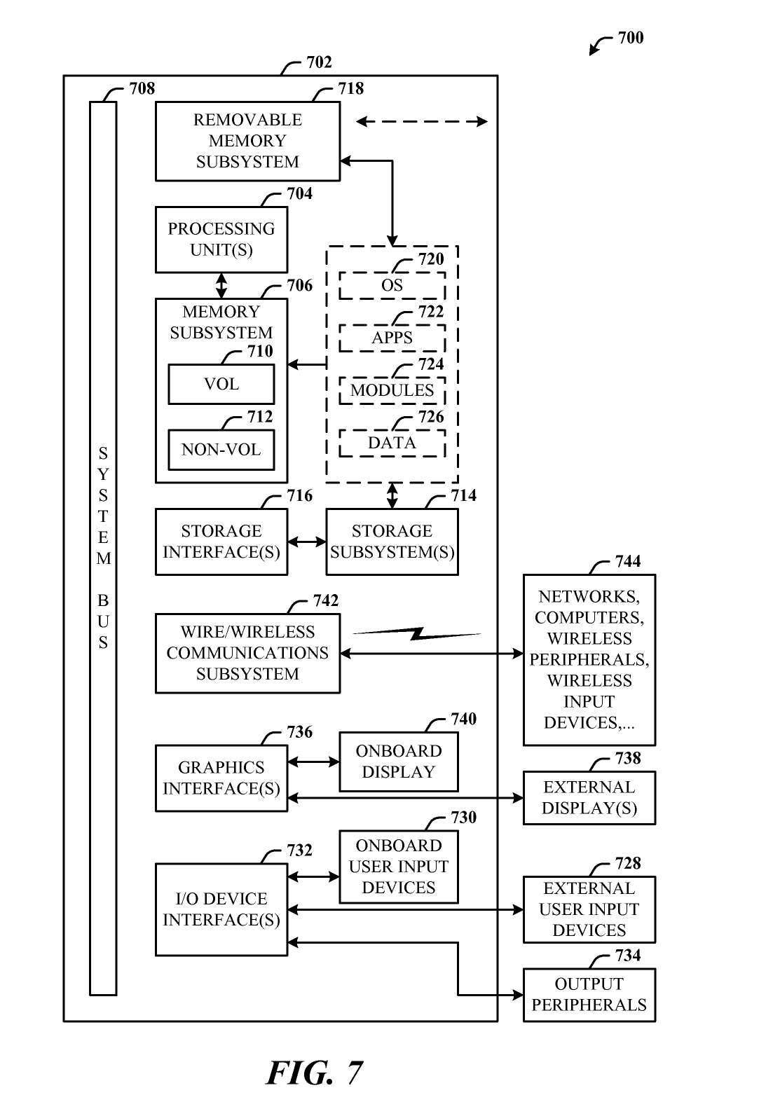

Referring now to FIG. 7, there is illustrated a block diagram of a computing system 700 that executes disparate taxonomy matching and mapping in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.), A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), and/or optical disk storage drive (e.g., a CD-ROM drive DVD drive), for example. The storage interface(s) 716 can include interface technologies such as HIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The operating system 720, one or more application programs 722, other program modules 724, and/or program data 726 can include entities and components of the system 100 of FIG. 1, steps associated with the blocks in the flow diagram 200 of FIG. 2, and the methods represented by the flowcharts of FIGS. 3-6, for example.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse, and voice using a voice recognition subsystem. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 cars also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a mapping component
that generates mappings between items of different taxonomies or mappings between items of a single taxonomy, and
that computes the mappings as a probability that the items are related, the probability computed by dividing a number of relevant documents by a number of all documents and document categories of all of the documents are the same as a class of the query intent;
a learning component that learns the mappings and outputs feature values for use by a ranking algorithm; and
a processor that executes computer-executable instructions associated with at least one of the mapping component or the learning component.

2. The system of claim 1, wherein the items of the different taxonomies are query intent of a first taxonomy and categories of results of a second taxonomy.

3. The system of claim 2, wherein the mapping component computes query intent entropy over all items of query intent.

4. The system of claim 1, wherein the items of the single taxonomy are categories of results of query intent of a query.

5. The system of claim 1, wherein the mappings are characterized as scores that are ranked to select an optimum mapping.

6. (canceled)

7. The system of claim 1, wherein the mapping component translates classes derived by a classifier between items of the taxonomies or between categories of the single taxonomy.

8. The system of claim 7, wherein the mapping component applies a threshold to limit membership of query intent and the classes.

9. A method, comprising acts of:
receiving a taxonomy of items related to a query and a different taxonomy of items related to search results;
creating mappings between items of different taxonomies or mappings between items of a single taxonomy by computing the mappings as a probability that the items are related, the probability computed by dividing a number of relevant documents by a number of all documents, and document categories of all of the documents are the same as the class of a query intent;
learning the mappings;
generating a match signal from the mappings for use in a ranking algorithm; and
utilizing a processor that executes instructions stored in memory to perform at least one of the acts of receiving, creating, learning, or generating.

10. The method of claim 9, further comprising creating the mappings between items of the taxonomy.

11. The method of claim 9, further comprising creating the mappings between the items of the taxonomy and the items of the different taxonomy.

12. The method of claim 9, further comprising creating the mappings between items of the taxonomy and, creating mappings between the items of the taxonomy and the items of the different taxonomy.

13. The method of claim 9, further comprising computing query intent entropy over all items of query intent related to the query.

14. The method of claim 9, further comprising applying a threshold to limit membership of query intent and categories of the search results.

15. The method of claim 9, further comprising training the ranking algorithm using the match signal.

16. A method, comprising acts of:
receiving query intent of a query of a first taxonomy and documents of a different taxonomy, the documents returned in association with processing of the query;
classifying the documents into document categories;
creating a mapping between the document categories and the query intent based on mapping data, the mapping data being a translation model that estimates predictions between document categories and the query intent;
generating feature signals from the mapping data for use in a ranker algorithm; and
utilizing a processor that executes instructions stored in memory to perform at least one of the acts of receiving, classifying, creating, or generating.

17. The method of claim 16, further comprising employing classifier algorithms to derive the query intent and classify the document categories.

18. The method of claim 16, further comprising computing the mapping data as a probability that the documents are related to the query intent.

19. The method of claim 16, further comprising training the ranking algorithm using the feature signals and other training data.

20. The method of claim 16, further comprising computing a feature signal per each item of query intent.
